(19) United States
(12) Patent Application Publication
(10) Pub. No.: US 2026/0074881 A1
(43) Pub. Date: Mar. 12, 2026

(54) FORWARD-SECURE AND QUANTUM-ATTACK-RESISTANT UPDATABLE ATTRIBUTE-BASED CONDITIONAL PROXY RE-ENCRYPTION METHOD

(71) Applicant: Jinan University, Guangzhou (CN)

(72) Inventors: Jian WENG, Guangzhou (CN); Bimei WANG, Guangzhou (CN); Shuang SHENG, Guangzhou (CN); Zhen HAN, Guangzhou (CN); Jiasi WENG, Guangzhou (CN)

(21) Appl. No.: 19/391,766

(22) Filed: Nov. 17, 2025

(30) Foreign Application Priority Data
Mar. 17, 2025 (CN) 202510313508.5

(51) Int. Cl. H04L 9/06; H04L 9/16

(52) U.S. Cl. CPC H04L 9/0618; H04L 9/16

(57) ABSTRACT

The present invention provides a computer-implemented method for forward-secure and quantum-attack-resistant updatable attribute-based conditional proxy re-encryption. The method includes: generating and disclosing public parameters by an authorization manager; generating public-private key pairs for delegator and delegatee; encrypting a plaintext using the delegator's public key and an attribute vector to produce a ciphertext; generating an updated public key and updated ciphertext for the delegatee; generating a re-encryption key associated with a control strategy; re-encrypting the ciphertext via a re-encryption component to produce a re-encrypted ciphertext; generating an updated private key by the delegatee; and decrypting the ciphertext or re-encrypted ciphertext using the updated private key. Based on lattice-based cryptography and an asynchronous key update mechanism, the method achieves forward security, quantum resistance, and fine-grained access control for secure data sharing.

### CROSS REFERENCE TO RELATED APPLICATION

This application is based upon and claims priority to Chinese Patent Application No. 202510313508.5, filed on Mar. 17, 2025, the entire content of which is incorporated herein by reference.

### TECHNICAL FIELD

The present disclosure relates to the field of cyber security technology, and more particularly to an updatable attribute-based conditional proxy re-encryption method that provides forward security, and resistance against quantum attacks. This present is suitable for scenarios where the delegator does not fully trust the delegatee. Specifically, it is applicable to application scenarios in which the delegator could implement attributed-based control on the delegation of decryption rights by setting conditions in the form of access structure and attribute set.

### BACKGROUND

Basic PRE schemes in the prior art lack flexible delegation mechanisms. For example, once a proxy obtains a re-encryption key, it can convert all ciphertexts of the delegator computing device into ciphertexts decryptable by the delegatee computing device, even if some of these ciphertexts are highly confidential and unsuitable for sharing. This necessitates absolute trust in the proxy, which is impractical in complex application scenarios.

To address authorization control, the prior art introduces conditional proxy re-encryption, associating ciphertexts and re-encryption keys with specific conditions to control the re-encryption process. Only when the conditions embedded in the ciphertext and the re-encryption key match can the ciphertext be correctly transformed. Nevertheless, conditional proxy re-encryption presents an unresolved challenge: constructing a conditional PRE method under specific conditions. To tackle this, the prior art has proposed two types of conditional PRE. The first is fuzzy conditional proxy re-encryption, which allows ciphertext transformation even when the re-encryption key condition and the ciphertext condition do not exactly match. The second is attribute-based conditional proxy re-encryption, which combines attributes and conditional controls to offer finer-grained access control for the delegator computing device. However, the security of the above PRE schemes relies on traditional number-theoretic problems and is thus vulnerable to quantum computer attacks. Furthermore, these schemes lack forward security for the delegatee computing device; once a key is compromised, severe consequences may arise.

### SUMMARY

To address the deficiencies of the prior art, the present disclosure provides a forward-secure and quantum-attack-resistant updatable attribute-based conditional proxy re-encryption method. This method instantiates updatable attribute-based conditional proxy re-encryption by leveraging hard problems on lattices, namely, the Learning With Errors (LWE) problem, to realize an updatable attribute-based conditional proxy re-encryption scheme. The result is a method that is not only resistant to quantum attacks but also capable of fine-grained transformation of re-encrypted ciphertexts. The present disclosure not only enhances the security of data sharing but also improves the flexibility and robustness of its application.

The present disclosure proposes a computer-implemented method of forward-secure and quantum-attack-resistant updatable attribute-based conditional proxy re-encryption, the method comprises:
S1. Generating and disclosing public parameter by an authorization manager;
S2. Generating public-private key pairs for both a delegator and a delegatee based on the public parameter by the authorization manager;
S3. Encrypting a plaintext by the delegator based on the public parameter, a public key of the delegator, and an attribute vector to generate a ciphertext, and sending the ciphertext to a re-encryption component;
S4. Generating, by the delegator computing device, an updated public key for the delegatee and an updated ciphertext for updating a private key of the delegatee, based on a public key of the delegatee;
S5. Generating, by the delegator computing device, a re-encryption key associated with a control strategy based on the public parameter, the public-private key pair of the delegator, an updated public key of the delegatee computing device, and the control strategy;
S6. Re-encrypting the ciphertext using the re-encryption key by the re-encryption component to generate a re-encrypted ciphertext, and sending the re-encrypted ciphertext to the delegatee computing device;
S7. Generating an updated private key by the delegatee computing device based on the private key of the delegatee computing device and the updated ciphertext for updating the private key of the delegatee computing device;
S8. Decrypting the ciphertext or the re-encrypted ciphertext by the delegatee computing device based on the public parameter, the private key of the delegator computing device or the updated private key

$$s {k}_{α}^{′}$$

of the delegatee computing device.

Preferably, in step S1, the authorization manager executes a Setup algorithm to input a security parameter n, then randomly and uniformly choosing/matrices B₁, B₂, . . . , Bₗ from a n×kn dimensional random matrix, where in each element constituting the matrix belongs to [symbol] _{q}^{n×kn} distribution, a group of integers of modulus q; an output is the public parameter pp=(B₁, B₂, . . . , Bₗ, χ) of the system, where χ is a noise-sampling Gaussian distribution.

Preferably, in step S2, the authorization manager generates the public-private key pairs for both the delegator computing device and the delegatee computing device by executing a KeyGen algorithm, the step S2 further comprises:
S21. Executing a trapdoor generation algorithm TrapGen to obtain matrix A_{α} and trapdoor T_{A}_{_{α}} based on the public parameter pp and an identity α of the delegator computing device; i.e:

$$( {A}_{α} , {T}_{{A}_{α}} ) ← TrapGen ( {1}^{n} , m , q ) ;$$

S22. Randomly and uniformly choosing one matrix D_{α} from a n×kn dimensional random matrix, i.e. m=kn, D_{α}← [symbol] _{q}^{n×m}, and executing a sampling algorithm SamplePre to generate a sampling matrix R_{α} based on the matrix A_{α}, the trapdoor T_{A}_{_{α}}, matrix-D_{α}, and a Gaussian parameter σ; then outputting the public-private key pair (pk_{α}, sk_{α}) of the delegator computing device; wherein, the public key pk_{α}=(A_{α}, D_{α}), the private key sk_{α}=(T_{A}_{_{α}}, R_{α}); and
S23. Repeating step S21 and step S22 to obtain the public key of the delegatee computing device pk_{β}=(A_{β}, D_{β}) and the private key of the delegatee computing device sk_{β}=(T_{A}_{_{β}}, R_{β}).

Preferably, in step S3, the delegator computing device encrypts the plaintext by an Encrypt algorithm to obtain the ciphertext based on the public parameter, the public key and the attribute vector of the delegator computing device, the step S3 further comprises:
S31. Randomly and uniformly choosing

$$s {⟵}^{\$} {ℤ}_{q}^{n} ,$$

eᵢₙ∈χ^{m}, eₒᵤₜ∈χ^{m};
where s denotes an unknown n-dimensional secret vector randomly chosen from the [symbol] _{q}ⁿ distribution, $ denotes a random uniform sampling, eᵢₙ and eₒᵤₜ respectively denotes an m-dimensional random noise vector, each element of the m-dimensional random noise vector is independently generated according to a Gaussian distribution, and χ^{m} denotes an m-dimensional vector set with each element belonging to an χ distribution;
S32. Calculating elements cᵢₙ, cₒᵤₜ of a first part ct_{α,x} of the ciphertext c_{α,x}, namely,

$$\begin{matrix}c {t}_{α , x} = ( {c}_{i n} , {c}_{out} ) \\ {c}_{i n} = {A}_{α}^{T} s + {e}_{i n} ; \\ {c}_{out} = {D}_{α}^{T} s + {e}_{out} + μ ⌊ \frac{q}{2} ⌋ ;\end{matrix}$$

wherein matrices A_{α} and D_{α} are two components of the public key pk_{α} of the delegator computing device, μ denotes a plaintext message, q denotes the lattice modulus, and T denotes the transpose of matrix, i.e. A_{α}^{T} denotes the transpose of matrix A_{α},

$${D}_{α}^{T}$$

denotes the transpose of matrix D_{α};
S33. Calculating a second part cc_{α,x} of the ciphertext;
when the attribute vector x is empty, cc_{α,x}=Ø; otherwise,

$$c {c}_{α , x} = ( {\{ {c}_{i} = {( {x}_{i} G + {B}_{i} )}^{T} s + {S}_{i}^{T} {e}_{i n} \}}_{i ∈ [ l ]} ) ∈ {ℤ}_{q}^{l m} ;$$

where Ø denotes empty set; cc_{α,x} denotes the second part of the ciphertext c_{α,x}; cᵢ denotes a computation result of a matrix vector

$${( {x}_{i} G + {B}_{i} )}^{T} s + {S}_{i}^{T} {e}_{i n} ; {x}_{i}$$

denotes an i-th component of an l-dimensional attribute vector x; Bᵢ denotes a matrix contained in the public parameter;

$${S}_{i}^{T}$$

denotes an m×kn-dimensional matrix with all elements being either 1 or −1; [symbol] _{q}^{lm} denotes an lm-dimensional vector space, wherein each component of a vector belonging to the distribution is independently and uniformly sampled at random from a finite field [symbol] _{q}, and each component of the vector belongs to [symbol] _{q}; l denotes the maximum value of i; m denotes the lattice dimension; G denotes the gadget matrix; and for the integers q≥2, n≥1, k=┌log q┐, and g^{T}=(1, 2, . . . , 2^{k-1})∈ [symbol] _{q}^{k}, a gadget matrix G with relatively unique form is constructed as follows:

$$G = {I}_{n} ⊗ {g}^{T} = [ \begin{matrix}{g}^{T} & & \\ & ⋱ & \\ & & {g}^{T}\end{matrix} ] ∈ {ℤ}_{q}^{n \times k n} ;$$

where [symbol] ₙ denotes a unit matrix of n rows; g^{T} denotes a first part of a re-encryption key; ⊗ denotes the Kronecker product of two matrices connected to it;
S34. Obtaining the ciphertext c_{α,x}=(ct_{α,x}, cc_{α,x}).

Preferably, in step S4, the delegator computing device executes an Update-pk algorithm and, based on the public key of the delegatee computing device, generates an updated public key for the delegatee computing device, along with a ciphertext for updating the private key of the delegatee computing device, the step S4 further comprises:
S41. Randomly and uniformly selecting a matrix

$${R}_{β}^{′} ← {ℤ}_{q}^{m \times m} ;$$

S42. Converting each element of the matrix

$${R}_{β}^{′}$$

into binary, then encrypting a bit of every element of the matrix by using a parallel computing or multithreading approach, and finally reassembling them into a matrix, namely,

$$Encrypt ( pp , p {k}_{β} , μ ∈ {\{ 0 , 1 \}}^{m} , {R}_{β}^{′} ) \to up ;$$

where pk_{β} is the public key of the delegatee computing device, Encrypt denotes encryption algorithm, pp denotes public parameters, μ denotes the plaintext message, m denotes the rank of the lattice, and up denotes the ciphertext for updating the private key of the delegatee computing device; thereby obtaining the ciphertext up for updating the private key of the delegatee computing device;
Calculating

$${D}_{β}^{Update} = {D}_{β} - {A}_{β} {R}_{β}^{′}$$

to obtain an updated public key

$$p {k}_{β}^{′} = ( {A}_{β} , {D}_{β}^{Update} )$$

for the delegatee computing device;
where, A_{β} denotes a first part of the initial public key and the updated public key of the delegatee computing device; D_{β} denotes a second part of the initial public key of the delegatee computing device;

$${D}_{β}^{Update}$$

denotes a second part of the updated public key of the delegatee computing device, and

$${R}_{β}^{′}$$

denotes a matrix randomly and uniformly chosen from [symbol] _{q}^{m×m} distribution.

Preferably, in step S5, the delegator computing device generates the re-encryption key associated with the control strategy by executing a ReKeyGen algorithm, the step S5 further comprises:
S51. Calculating B_{f} based on the control strategy f and the public parameter pp=(B₁, . . . , Bₗ, ×):

$${B}_{f} = {Eval}_{p k} ( f , {\{ {B}_{i} \}}_{i ∈ [ l ]} ) ;$$

where f is a strategy function; Bᵢ is a matrix contained in the public parameter; and B_{f} is an output of the Evalₚₖ algorithm;

Given positive integers n, q, [symbol] , m=[6n log q], matrices B₁, . . . , [symbol] ∈ [symbol] _{q}^{n×m}, an arbitrary control strategy f, x={x₁, . . . , [symbol] }∈{0,1 [symbol] , if ∀i∈[ [symbol] ]: cᵢ=(xᵢG+Bᵢ)^{T}s+eᵢ is satisfied, where

$$s ← {ℤ}_{q}^{n} ,$$

eᵢ←χ^{m}, then there exist three deterministic fully homomorphic encryption algorithms, namely, Eval_{ct}, Evalₚₖ and Evalₛᵢₘ;
\textcircled{1} Evalₚₖ(f, {Bᵢ [symbol] )→B_{f}: input of the Evalₚₖ algorithm including B₁, . . . ,

$${B}_{ℓ} ∈ {ℤ}_{q}^{n \times m}$$

and a control strategy f, the output is a matrix B_{f};
\textcircled{2} Eval_{ct}(f, {xᵢ, Bᵢ, cᵢ [symbol] )→c_{f}: input of the Eval_{ct} algorithm including f, B₁, . . . ,

$${B}_{ℓ} ∈ {ℤ}_{q}^{n \times m} ,$$

xᵢ∈{0, 1}, and cᵢ=(xᵢG+Bᵢ)^{T}s+eᵢ; where G is a Gadget matrix, and the output is c_{f} which satisfies c_{f}=(f(x)G+B_{f})^{T}s+e_{f}, where ∥e_{f}∥≤B\sqrt{m}(m+1)^{d}; s denotes an unknown n-dimensional secret vector randomly chosen from the [symbol] _{q}ⁿ distribution, B denotes bounded, m denotes the rank of the lattice, x denotes attribute vector;

$${Eval}_{sim} ( f , {\{ {x}_{i}^{*} , {S}_{i} \}}_{i ∈ [ ℓ ]} , A ) \to {S}_{f} :$$

input of the Evalₛᵢₘ algorithm including the control strategy f,

$${x}_{i}^{*} ∈ \{ 0 , 1 \} ,$$

Sᵢ∈{−1, 1}^{m×m}, and the matrix A, and the output is the matrix S_{f} which satisfies AS_{f}−f(x)G=B_{f}, where B_{f} is the output of the algorithm Evalₚₖ;
S52. Calculating the trapdoor T_{(A}_{_{α}}_{|B}_{_{f}}₎ of matrix A_{α}|B_{f} based on the public key pk_{α}=(A_{α}, D_{α}) and private key sk_{α}=(T_{A}_{_{α}}, R_{α}) of the delegator computing device:

$${T}_{( {A}_{α} \vert {B}_{f} )} ← ExtendRight ( {A}_{α} , {T}_{{A}_{α}} , {B}_{f} ) ,$$

where T_{(A}_{_{α}}_{|B}_{_{f}}₎ denotes the trapdoor of matrix A_{α}|B_{f}; ExtendRight denotes a rightward expansion algorithm, specifically: ExtendRight(A, T_{A}, U): input a random matrix

$$A ∈ {ℤ}_{q}^{n \times m} ,$$

a trapdoor

$${T}_{A} ∈ {ℤ}_{q}^{m \times m}$$

for lattice Λ(A), and an arbitrary matrix

$$U ∈ {ℤ}_{q}^{n \times m} ,$$

output a trapdoor T_{A|U} for lattice

$${Λ}_{q}^{⊥} ( A \vert U )$$

which satisfying ∥ [symbol] ∥=∥ [symbol] ∥;
S53. Computing a preimage R_{α,f} of matrix (A_{α}|B_{f}) based on the trapdoor T_{(A}_{_{α}}_{|B}_{_{f}}₎ of the matrix A_{α}|B_{f}:

$${R}_{a , f} ← SamplePre ( ( {A}_{α} \vert {B}_{f} ) , {T}_{( {A}_{α} \vert {B}_{f} )} , - {D}_{α} , σ )$$

where R_{α,f} denotes the preimage of matrix (A_{α}|B_{f}), σ is the Gaussian parameter, and SamplePre is a preimage sampling algorithm, specifically: the SamplePre algorithm inputs a matrix

$$A ∈ {ℤ}_{q}^{n \times m} ,$$

a trapdoor

$${T}_{A} ∈ {ℤ}_{q}^{m \times m} ,$$

a vector

$$u ∈ {ℤ}_{q}^{n} ,$$

and a Gaussian parameter τ≥∥ [symbol] ∥ω(\sqrt{log m}), then a vector

$$e ∈ {ℤ}_{q}^{m}$$

is sampled from the discrete Gaussian distribution

$${𝒟}_{{Λ}_{q}^{u} ( A ) , τ}$$

satisfying Ae=u;
S54. Calculating a first part g^{T} of the re-encryption key based on the updated public key

$${pk}_{β}^{′} = ( {A}_{β} , {D}_{β}^{Update} )$$

of the delegatee computing device:

$${g}^{T} = {r}_{1}^{T} ( {A}_{β} \vert {D}_{β}^{Update} ) + ( {\tilde{e}}_{0}^{T} \vert {\tilde{e}}_{1}^{T} ) ∈ {ℤ}_{q}^{1 \times 2 m}$$

where g^{T} denotes a first part of the re-encryption key r_{kα,f→β};

$${r}_{1}^{T}$$

denotes the transpose of the vector r₁, where

$${r}_{1} {←}^{\$} {ℤ}_{q}^{n} ; {\tilde{e}}_{0}^{T} , {\tilde{e}}_{1}^{T}$$

denote two random m-dimensional vectors sampled from the noise sampling Gaussian distribution χ respectively, i.e.,

$${\tilde{e}}_{0} {←}^{\$} {𝒳}^{m} , {\tilde{e}}_{1} {←}^{\$} {𝒳}^{m} ;$$

S55. Computing a second part Q of the re-encryption key rk_{α,f→β}:

$$Q = ( \begin{matrix}{E}_{1} {A}_{β} + {E}_{2} & {E}_{1} {D}_{β}^{Update} + {E}_{3} + P 2 ( {R}_{α , f} ) \\ {0}_{m \times m} & {I}_{m \times m}\end{matrix} ) ∈ {ℤ}_{q}^{( 2 k + 1 ) m \times 2 m} ;$$

where Q denotes the second part of the re-encryption key rk_{α,f→β}; E₁, E₂, E₃ respectively denote matrices 2 km×n, 2 km×m, 2 km×m randomly sampled from a noise distribution, i.e.,

$${E}_{1} {←}^{\$} {𝒳}^{2 km \times n} , {E}_{2} {←}^{\$} {𝒳}^{2 km \times m} , {E}_{3} {←}^{\$} {𝒳}^{2 km \times m} ; {0}_{m \times m}$$

denotes a zero matrix, namely, all elements of the matrix is 0; I_{m×m} denotes a unit matrix, namely, all elements of the positive diagonal of the matrix is 1; and P2 denotes the second one of the vector decomposition function, specifically: vector decomposition function: suppose BD(v) and P2(x) are deterministic functions that map vectors to higher-dimensional spaces, let vᵢ∈{0,1}ⁿ and the vector

$$v = {\sum }_{i = 0}^{⌈ log q ] - 1} {2}^{i} {v}_{i} ,$$

the BD(v) function takes a vector v as input and outputs a higher-dimensional vector \tilde{v}=(v₀; . . . ; v_{┌log q┐-1})∈{0,1}^{n┌log q┐}; similarly, P2(x) function takes a vector x∈ [symbol] _{q}ⁿ as input and outputs a higher-dimensional vector

$$\overline{x} = ( x ; 2 x ; … ; {2}^{⌈ log q ] - 1} x ) ∈ {ℤ}_{q}^{n ⌈ log q ]} ;$$

the relationship between BD(v) and P2(x) satisfies BD(v)^{T}·P2(x)=v^{T}x=\tilde{v}^{T}x̅;
S56. Obtaining the re-encryption key rk_{α,f→β} associated with the control strategy f:

$${rk}_{α , f \to β} = \{ {g}^{T} , Q \} .$$

Preferably, in step S6, the re-encryption component executing a ReEncrypt algorithm to re-encrypt the ciphertext based on the re-encryption key, the step S6 further comprises:
S61. Outputting the terminator 1 when the control strategy f≠0 or cc_{α,x}=Ø; otherwise, ct_{α,x}=(cᵢₙ, cₒᵤₜ),

$${cc}_{α , x} = ( {\{ {c}_{i} \}}_{i ∈ [ l ]} ) ∈ {ℤ}_{q}^{lm} ;$$

S62. Randomly choosing a small integer a∈χ, and calculating c_{f} and

$$c {t}_{β}^{T} ,$$

i.e.:

$$\begin{matrix}{c}_{f} ← {Eval}_{ct} ( f , {\{ ( {x}_{i} , {B}_{i} , {c}_{i} ) \}}_{i ∈ [ l ]} ) \\ {ct}_{β}^{T} = {ag}^{T} + ( BD ( {c}_{f}^{′ T} ) \vert {c}_{out}^{T} ) \cdot Q\end{matrix}$$

where c_{f} is the result obtained by running the Eval_{ct} algorithm;

$${ct}_{β}^{T}$$

denotes the transpose of the first part ct_{β} of the re-encrypted ciphertext c_{β}; f is the strategy function; xᵢ denotes the component of the attribute vector x; Bᵢ is the public parameter; cᵢ is the element of the second part cc_{α,x} of the ciphertext c_{α,x}; g^{T} denotes the first part of the re-encryption key rk_{α,f→β}; BD denotes one of the vector decomposition functions;

$${c}_{f}^{′ T}$$

denotes the cascade of the matrices cᵢₙ and c_{f}, i.e. [cᵢₙ|c_{f}]; and Q denotes the second part of the re-encryption key rk_{α,f→β};
S63. Outputting re-encrypted ciphertext c_{β}:

$${c}_{β} = ( {ct}_{β} , {cc}_{β} = ∅ ) ;$$

where ct_{β}, cc_{β} respectively denote the first part and the second part of the re-encrypted ciphertext c_{β}.

Preferably, in step S7, the delegatee computing device executing an Update−sk algorithm to obtain an updated private key based on the private key and the ciphertext for updating the private key, the step S7 further comprises:
S71. First decrypting each element of the ciphertext up for updating the private key of the delegatee computing device using a parallel computing or multithreading approach;
S72. Converting a bit string obtained by decryption into the [symbol] _{q}^{n×m} distribution, and recombining to obtain matrix

$${R}_{β}^{′} ;$$

S73. Outputting the updated private key

$$s {k}_{β}^{′} ,$$

i.e:

$$s {k}_{β}^{′} = ( {T}_{{A}_{β}} , {R}_{β}^{Update} )$$

where T_{A}_{_{β}} denotes the trapdoor of the delegatee computing device β;

$${R}_{β}^{Update} = {R}_{β} + {R}_{β}^{′}$$

denotes the second part of the updated private key of the delegatee computing device.

The delegatee computing device decrypts the ciphertext or re-encrypted ciphertext by executing a Decrypt algorithm based on the public parameter, the private key of the delegatee computing device, or the updated private key sk_{β}′ of the delegatee computing device, the step S8 further comprises:
S81. Decrypting the original ciphertext c_{β,x}. Calculating

$$\begin{matrix}{μ}^{′} = [ \begin{matrix}{c}_{in}^{T} & {c}_{out}^{T}\end{matrix} ] . \\ [ \begin{matrix}{R}_{β} \\ {I}_{m \times m}\end{matrix} ]\end{matrix}$$

according to the public parameter pp=(B₁, . . . , Bₗ, χ), an initial private key of the delegator

$${sk}_{β} = ( {T}_{{A}_{β}} , {R}_{β} )$$

and an initial ciphertext

$${ct}_{a , x} = ( {C}_{in} , {C}_{out} ) = ( {A}_{β}^{T} s + {e}_{in} , {D}_{β}^{T} s + {e}_{out} + μ ⌊ \frac{q}{2} ⌋ )$$

encrypted under the public key pk_{β} of the delegator computing device;
S82. Decrypting the Re-encrypted Ciphertext c_{β}. Calculating

$$\begin{matrix}{μ}^{′} = [ \begin{matrix}{c}_{in}^{T} & {c}_{out}^{T}\end{matrix} ] . \\ [ \begin{matrix}{R}_{β}^{Update} \\ {I}_{m \times m}\end{matrix} ]\end{matrix}$$

according to the public parameter pp=(B₁, . . . , Bₗ, χ), the updated private key of the delegatee computing device

$${sk}_{β}^{′} = ( {T}_{{A}_{β}} , {R}_{β}^{Update} )$$

and the re-encrypted ciphertext c_{β}=(ct_{β}, cc_{β}=Ø) encrypted under the public key

$${pk}_{β}^{′} .$$

The present disclosure has the following advantages.

1. The present disclosure proposes a technical solution for updatable attribute-based conditional proxy re-encryption. Based on an asynchronous key update mechanism, the solution allows for the periodic rotation of the delegatee computing device's public and private keys, thereby achieving forward security. Additionally, by means of a control structure, fine-grained control over ciphertext transformation is realized.

2. Leveraging the Learning With Errors (LWE) problem, the disclosure provides a scheme that is resistant to quantum attacks and supports fine-grained transformation of re-encrypted ciphertexts. This enhancement improves the security of data sharing systems and increases the flexibility and robustness of the application.

3. The present disclosure demonstrates significant advantages in terms of data privacy and security and is applicable to cloud storage and distributed file systems.

### BRIEF DESCRIPTION OF THE DRAWINGS

FIG. 1 is a schematic flow diagram of the method of the present disclosure.

FIG. 2 is a framework diagram of the method according to an embodiment of the present disclosure.

FIG. 3 is a chart showing the runtime testing of eight algorithms contained in UAB-CPRE when n=16 according to an embodiment of the present disclosure.

FIG. 4 is a chart showing the runtime testing of eight algorithms contained in UAB-CPRE when n=32 according to an embodiment of the present disclosure.

FIG. 5 is a chart showing the runtime testing of eight algorithms contained in UAB-CPRE when n=64 according to an embodiment of the present disclosure.

FIG. 6 is a chart showing the runtime of the TrapGen algorithm with different lattice ranks and different parameters q according to an embodiment of the present disclosure.

FIG. 7 is a chart showing the runtime of the SamplePre algorithm with different lattice ranks and different parameters q according to an embodiment of the present disclosure.

FIG. 8 is a framework diagram of the method according to another embodiment of the present disclosure.

FIG. 9 is a chart showing theoretical time complexity analysis of the UAB-CPRE scheme of the present disclosure.

### DETAILED DESCRIPTION OF THE EMBODIMENTS

Specific embodiments of the present disclosure are further described below in conjunction with the accompanying drawings.

As used herein, the term “re-encryption component” refers to any computing device, system, or network node, trusted or semi-trusted, that is configured to receive a re-encryption key and a ciphertext, and to perform cryptographic operations to transform said ciphertext into a different ciphertext that is intended for a different recipient, without learning the underlying plaintext. The re-encryption component is characterized by its function (re-encrypting data) rather than its specific physical implementation or architectural role. Accordingly, the term “re-encryption component” should be construed broadly to encompass, including but not limited to, the following entities: 1. a cloud server in a centralized or distributed cloud computing environment; 2. a mining node or validator node within a blockchain or distributed ledger technology (DLT) network, in this context, the re-encryption function may be implemented as a smart contract or a predefined operation executed by the node as part of the blockchain's consensus or state transition mechanism; 3. an edge computing device in a fog or edge computing architecture; 4. a dedicated proxy server or a gateway appliance; 5. a decentralized peer in a peer-to-peer (P2P) network.

The core functionality of the re-encryption component, as described throughout this specification, comprises: (i) receiving a re-encryption key rk_{α,f→β} associated with a delegator α and a delegatee β; (ii) receiving a ciphertext c_{α,x} encrypted under the delegator's public key; and (iii) computing a transformed ciphertext c_{β} using the algorithm ReEncrypt (rk_{α,f→β},c_{α,x}) such that c_{β} can be decrypted by the delegatee's private key. The specific cryptographic algorithms performing this transformation (e.g., lattice-based operations) are detailed in the corresponding sections below.

As used herein, the term “delegator computing device” or “delegatee computing device” refers broadly to any physical or virtualized information processing apparatus equipped with one or more processors, memory, and communication interfaces, configured to execute instructions for performing computational, cryptographic, or data handling operations described in this disclosure. The term is defined by its functional capability to process data and execute algorithms, rather than by a specific physical form or hardware architecture. Accordingly, a “computing device” encompasses, including but not limited to: a server in a centralized or distributed cloud computing environment, a node within a blockchain or distributed ledger network (e.g., a mining node, validator node, or full node), an edge computing device or appliance in a fog or edge computing architecture, a personal computer, workstation, or laptop, a virtual machine or container instance running on a hypervisor or within a cloud infrastructure, a dedicated hardware security module (HSM) or cryptographic appliance, a peer in a peer-to-peer (P2P) network. The core characteristic of a “computing device” in the context of this disclosure is its ability to be programmed or configured to implement the cryptographic algorithms and protocols described herein, such as key generation, encryption, re-encryption, decryption, and key update operations. This functional definition ensures that the claimed methods and systems are not limited to a specific type of hardware or deployment model, but are applicable to any suitable processing platform capable of performing the required operations.

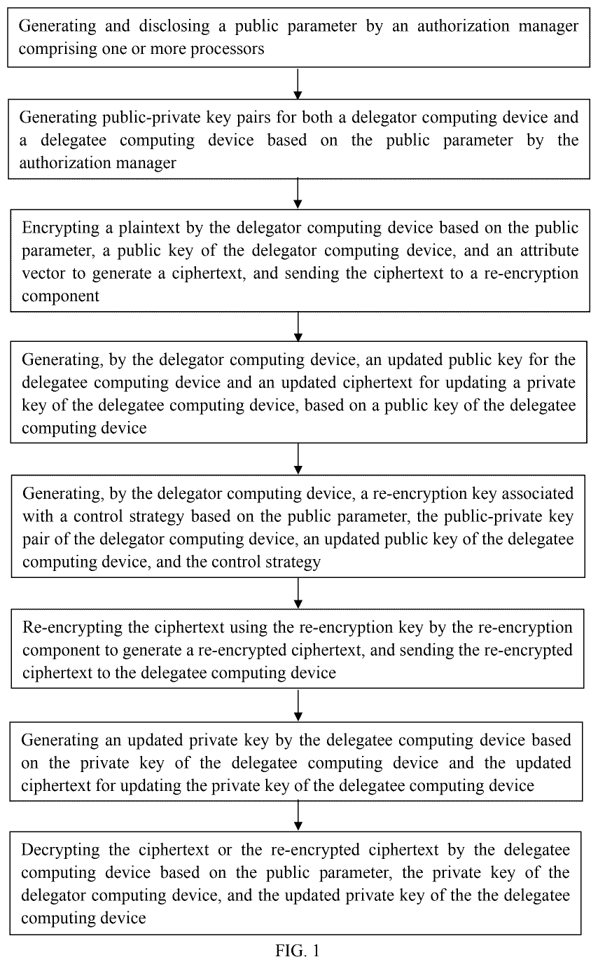

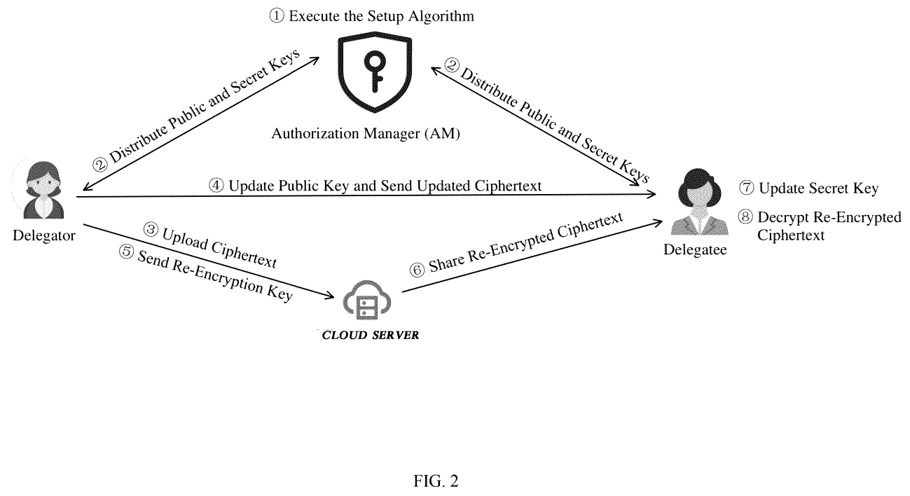

According to one embodiment of the present disclosure, as shown in FIGS. 1-2, the present embodiment provides aquantum-attack-resistant updatable attribute-based conditional proxy re-encryption method, and the present embodiment involves an authorization manager, a delegator computing device, a delegatee computing device, and a cloud server.

Further, the parameters involved in the present disclosure are described in the present embodiment below.

Specifically, (n, q, m, χ) are lattice parameters, where n is the rank of the lattice, q is the modulus, k=┌log q┐, m is the lattice dimension satisfying q=poly(n), m≥┌6n log q┐ and q/4≥B·(m+1)^{O(d)}, with χ following a B-bounded distribution, where B≥\sqrt{n}·ω(log n); l denotes the number of attributes supported by the scheme; σ is the Gaussian parameter, satisfying σ=ω((m+1)^{d+1})·ω(\sqrt{log m}); here ω denotes the lower bound, and its value is greater than the content within the parentheses; and the value of k=┌log q┐.

The encryption method of the present embodiment specifically includes the following steps:
S1. The authorization manager executes the Setup algorithm, generates and discloses public parameter pp, and in the initialization stage, the parameters are selected as follows:

(n, q, m, χ) are lattice parameters, where n is the rank of the lattice, q is the modulus, k=┌log q┐, m is the lattice dimension satisfying q=poly(n), m≥┌6n log q┐ and q/4≥B·(m+1)^{O(d)}, with χ following a B-bounded distribution, where B≥\sqrt{n}·ω(log n); l denotes the number of attributes supported by the scheme; σ is the Gaussian parameter, satisfying σ=ω((m+1)^{d+1})·ω(\sqrt{log m}); here ω denotes the lower bound, and its value is greater than the content within the parentheses; and the value of k=┌log q┐.

The step S1 may specifically include the following steps:
S11. The authorization manager executes the Setup algorithm which takes the security parameter n as input;
S12. Randomly and uniformly choosing matrices B₁, . . . ,

$${B}_{l} {←}^{\$} {ℤ}_{q}^{n \times kn} ;$$

S13. Calculating the system's public parameter pp=(B₁, . . . , Bₗ, χ), where χ represents the noise sampling Gaussian distribution.
S2. The authorization manager executes the KeyGen algorithm to output the public-private key pairs of the delegator computing device and delegatee computing device based on the public parameter; the step S2 may specifically include the following steps:
S21. Performing the following computation (A_{α}, T_{A}_{_{α}})←TrapGen(n, 1^{m}, q) to obtain the matrix A_{α} and its trapdoor T_{A}_{_{α}} based on the public parameter pp and the delegator computing device's identity α;
S22. Randomly and uniformly choosing one matrix

$${D}_{α} ← {ℤ}_{q}^{n \times m} ,$$

and then executing the sampling algorithm SamplePre based on the matrix A_{α}, the trapdoor T_{A}_{_{α}}, the matrix-Dα, and the Gaussian parameter σ to output sampling matrix R_{α}, thereby obtaining the public-private key pair of the delegator computing device (pk_{α}, sk_{α}); wherein, the public key pk_{α}=(A_{α}, D_{α}) and the private key sk_{α}=(T_{A}_{_{α}}, R_{α}).

Similarly, following steps S21 and S22 to obtain the public key pk_{β}=(A_{β}, D_{β}) and private key sk_{β}=(T_{A}_{_{β}}, R_{β}) corresponding to a delegatee computing device with identity β.
S3. The delegator computing device executes the Encrypt algorithm and encrypts the plaintext according to the public parameter and, the public key of the delegator computing device, and the attribute vector to generate the ciphertext, and sends the ciphertext to the cloud server; the step S3 may specifically include the following steps:
S31. Randomly and uniformly sampling

$$s {⟵}^{\$} {ℤ}_{q}^{n} ,$$

eᵢₙ∈χ^{m}, eₒᵤₜ∈χ^{m};
where s denotes an unknown n-dimensional secret vector randomly chosen from the [symbol] _{q}ⁿ distribution, $ denotes a random uniform sampling, eᵢₙ and eₒᵤₜ respectively denotes a n-dimensional random noise vector, each element of the n-dimensional random noise vector is independently generated according to a Gaussian distribution, and χ™ denotes a m-dimensional vector set with each element belonging to an χ distribution;
S32. Calculating the elements cᵢₙ, cₒᵤₜ contained in the first part ct_{α,x} of the ciphertext c_{α,x}, i.e.:

$$\begin{matrix}c {t}_{α , x} = ( {c}_{i n} , {c}_{out} ) \\ {c}_{i n} = {A}_{α}^{T} s + {e}_{i n} ; \\ {c}_{out} = {D}_{α}^{T} s + {e}_{out} + μ ⌊ \frac{q}{2} ⌋ ;\end{matrix}$$

where matrices A_{α} and D_{α} are two components of the public key pk_{α} of the delegator computing device, μ denotes a plaintext message, q denotes a modulus of the lattice, and T denotes a matrix transposition operation;
S33. Calculating the second part cc_{α,x} of the ciphertext;
when the attribute vector x is empty, cc_{α,x}=Ø; otherwise

$$c {c}_{α , x} = ( {\{ {c}_{i} = {( {x}_{i} G + {B}_{i} )}^{T} s + {S}_{i}^{T} {e}_{i n} \}}_{i ∈ [ l ]} ) ∈ {ℤ}_{q}^{l m} ;$$

where Ø denotes empty set; cc_{α,x} denotes the second part of the ciphertext c_{α,x}; cᵢ denotes a computation result of a matrix vector

$${( {x}_{i} G + {B}_{i} )}^{T} s + {S}_{i}^{T} {e}_{i n} ;$$

xᵢ denotes an i-th component of an l-dimensional attribute vector x; Bᵢ denotes a matrix contained in the public parameter;

$${S}_{i}^{T}$$

denotes a m×kn-dimensional matrix with all elements being either 1 or −1; [symbol] denotes an lm-dimensional vector space, wherein each component of a vector belonging to the distribution is independently and uniformly sampled at random from a finite field [symbol] _{q}, and each component of the vector belongs to [symbol] _{q}; l denotes the maximum value of i; m denotes the lattice dimension; G denotes the Gadget matrix; and for the integers q≥2, n≥1, k=┌log q┐, and

$${g}^{T} = ( 1 , 2 , … , {2}^{k - 1} ) ∈ {ℤ}_{q}^{k} ,$$

a Gadget matrix G with relatively unique form is constructed as follows:

$$G = {I}_{n} ⊗ {g}^{T} = [ \begin{matrix}{g}^{T} & & \\ & ⋱ & \\ & & {g}^{T}\end{matrix} ] ∈ {ℤ}_{q}^{n \times k n} ;$$

where Iₙ denotes a unit matrix of n rows; g^{T} denotes a first part of a re-encryption key; ⊗ denotes the Kronecker product of two matrices connected to it;
S34. Obtaining the ciphertext c_{α,x}=(ct_{α,x}, cc_{α,x}).
S4. The delegator computing device executes an Update-pk algorithm and, based on the public key of the delegatee computing device, generates an updated public key for the delegatee computing device, along with a ciphertext for updating the private key of the delegatee computing device, the step S4 may specifically includes the following steps:
S41. Randomly and uniformly selecting a matrix

$${R}_{β}^{′} ← {ℤ}_{q}^{m \times m} ;$$

S42. Converting each element of the matrix

$${R}_{β}^{′}$$

into binary, then encrypting a bit of every element of the matrix by using a parallel computing or multithreading approach, and finally reassembling them into a matrix, namely,

$$Encrypt ( pp , p {k}_{β} , μ ∈ {\{ 0 , 1 \}}^{m} , {R}_{β}^{′} ) ⟶ up ;$$

where pk_{β} is the public key of the delegatee computing device, a ciphertext up for updating the private key of the delegatee computing device is obtained;
S43. Calculating

$${D}_{β}^{Update} = {D}_{β} - {A}_{β} {R}_{β}^{′}$$

to obtain an updated public key

$$p {k}_{β}^{′} = ( {A}_{β} , {D}_{β}^{Update} )$$

for the delegatee computing device;
where, A_{β} denotes a first part of the initial public key and the updated public key of the delegatee computing device; D_{β} denotes a second part of the initial public key of the delegatee computing device;

$${D}_{β}^{Update}$$

denotes a second part of the updated public key of the delegatee computing device, and

$${R}_{β}^{′}$$

denotes a matrix randomly and uniformly chosen from [symbol] _{q}^{m×m} distribution.
S5. The delegator computing device generates the re-encryption key associated with the control strategy by executing a ReKeyGen algorithm based on the public parameter, the public-private key pair of the delegator computing device, the updated public key of the delegatee computing device, and the control strategy; the step S5 may specifically includes the following steps:
S51. Calculating B_{f} based on the control strategy f and the public parameter pp=(B₁, . . . , Bₗ, χ):

$${B}_{f} = {Eval}_{p k} ( f , {\{ {B}_{i} \}}_{i ∈ [ l ]} ) ;$$

where f is a strategy function; Bᵢ is a matrix contained in the public parameter; and B_{f} is an output of the Evalₚₖ algorithm.

In Full Homomorphic Encryption, given positive integers n, q, [symbol] , m=[6n log q], matrices B₁, . . . ,

$${B}_{ℓ} ∈ {ℤ}_{q}^{n \times m} ,$$

an arbitrary control strategy f, x={x₁, . . . , [symbol] }∈{0,1 [symbol] , if ∀i∈[ [symbol] ]: cᵢ=(xᵢG+Bᵢ)^{T}s+eᵢ is satisfied, where

$$s ← {ℤ}_{q}^{n} ,$$

eᵢ←χ^{m}, then there exist three deterministic algorithms, namely, Eval_{ct}, Evalₚₖ and Evalₛᵢₘ.
\textcircled{1} Evalₚₖ(f, {Bᵢ [symbol] )→B_{f}: input of the Evalₚₖ algorithm including B₁, . . . ,

$${B}_{ℓ} ∈ {ℤ}_{q}^{n \times m}$$

and a control strategy f, the output is a matrix B_{f}.
\textcircled{2} Eval_{ct}(f, {xᵢ, Bᵢ, cᵢ [symbol] )→c_{f}: input of the Eval_{ct} algorithm including f, B₁, . . . ,

$${B}_{ℓ} ∈ {ℤ}_{q}^{n \times m} ,$$

xᵢ∈{0,1}, and cᵢ=(xᵢG+Bᵢ)^{T}s+eᵢ; where G is a Gadget matrix, and the output is c_{f} which satisfies c_{f}=(f(x)G+B_{f})^{T}s+e_{f}, where ∥e_{f}∥≤B\sqrt{m}(m+1)^{d};
\textcircled{3} Evalₛᵢₘ(f,{xᵢ*,Sᵢ [symbol] , A)→S_{f}: input of the Evalₛᵢₘ algorithm including the control strategy f,

$${x}_{i}^{*} ∈ \{ 0 , 1 \} ,$$

Sᵢ∈{−1,1}^{m×m}, and the matrix A, and the output is the matrix S_{f} which satisfies AS_{f}−f(x)G=B_{f}, where B_{f} is the output of the algorithm Evalₚₖ.
S52. Calculating the trapdoor T_{(A}_{_{α}}_{|B}_{_{f}}₎ of matrix A_{α}|B_{f} based on the public key pk_{α}=(A_{α}, D_{α}) and private key sk_{α}=(T_{A}_{_{α}}, R_{α}) of the delegator computing device:

$${T}_{( {A}_{α} \vert {B}_{f} )} ← E x t e n d R i g h t ( {A}_{α} , {T}_{{A}_{α}} , {B}_{f} )$$

where T_{(A}_{_{α}}_{|B}_{_{f}}₎ denotes the trapdoor of matrix A_{α}|B_{f}; ExtendRight denotes a rightward expansion algorithm, specifically:

ExtendRight(A,T_{A},U): input a random matrix

$$A ∈ {ℤ}_{q}^{n \times m} ,$$

a trapdoor

$${T}_{A} ∈ {ℤ}_{q}^{m \times m}$$

for lattice Λ(A), and an arbitrary matrix

$$U ∈ {ℤ}_{q}^{n \times m} ,$$

output a trapdoor T_{A|U} for lattice

$${Λ}_{q}^{⊥} ( A \vert U )$$

which satisfying ∥ [symbol] ∥=∥ [symbol] ∥.
S53. Computing a preimage R_{α,f} of matrix (A_{α}|B_{f}) based on the trapdoor T_{(A}_{_{α}}_{|B}_{_{f}}₎ of the matrix A_{α}|B_{f}:

$${R}_{α , f} ← SamplePre ( ( {A}_{α} \vert {B}_{f} ) , {T}_{( {A}_{α} \vert {B}_{f} )} , - {D}_{α} , σ )$$

where R_{α,f} denotes the preimage of matrix (A_{α}|B_{f}), σ is the Gaussian parameter, and SamplePre is a preimage sampling algorithm, specifically:

The SamplePre algorithm inputs a matrix

$$A ∈ {ℤ}_{q}^{n \times m} ,$$

a trapdoor

$${T}_{A} ∈ {ℤ}_{q}^{m \times m} ,$$

a vector

$$u ∈ {ℤ}_{q}^{n} ,$$

and a Gaussian parameter τ≥∥ [symbol] ∥ω(\sqrt{log m}), then a vector e∈ [symbol] _{q}^{m} is sampled from the discrete Gaussian distribution

$${𝒟}_{{Λ}_{q}^{u} ( A ) , τ}$$

satisfying Ae=u.
S54. Calculating a first part g^{T} of the re-encryption key based on the updated public key pk_{β}′=(A_{β}, D_{β}^{Update}) of the delegatee computing device:

$${g}^{T} = {r}_{1}^{T} ( {A}_{β} \vert {D}_{β}^{Update} ) + ( {\tilde{e}}_{0}^{T} \vert {\tilde{e}}_{1}^{T} ) ∈ {ℤ}_{q}^{1 \times 2 m}$$

where g^{T} denotes a first part of the re-encryption key rk_{α,f→β};

$${r}_{1}^{T}$$

denotes the transpose of the vector r₁, where

$${r}_{1} {⟵}^{\$} {Z}_{q}^{n} ; \qquad {\tilde{e}}_{0}^{T} , {\tilde{e}}_{1}^{T}$$

denote two random m-dimensional vectors sampled from the noise sampling Gaussian distribution χ respectively, i.e., \tilde{e}₀ [symbol] χ^{m}, \tilde{e}₁ [symbol] χ^{m}.
S55. Computing a second part Q of the re-encryption key rk_{α,f→β}:

$$Q = ( \begin{matrix}{E}_{1} {A}_{β} + {E}_{2} & {E}_{1} {D}_{β}^{Update} + {E}_{3} + P 2 ( {R}_{α , f} ) \\ {0}_{m \times m} & {I}_{m \times m}\end{matrix} ) ∈ {ℤ}_{q}^{( 2 k + 1 ) m \times 2 m} ;$$

where Q denotes the second part of the re-encryption key rk_{α,f→β}; E₁, E₂, E₃ respectively denote matrices 2 km×n, 2 km×m, 2 km×m randomly sampled from an noise distribution, i.e.,

$${E}_{1} {←}^{\$} {χ}^{2 k m \times n} , {E}_{2} {←}^{\$} {χ}^{2 k m \times m} , {E}_{3} {←}^{\$} {χ}^{2 k m \times m} ;$$

O_{m×m} denotes a zero matrix, namely, all elements of the matrix m×m is 0; I_{m×m} denotes a unit matrix, namely, all elements of the positive diagonal of the matrix m×m is 1; and P2 denotes the second one of the vector decomposition function, specifically:

Vector decomposition function: suppose BD(v) and P2(x) are deterministic functions that map vectors to higher-dimensional spaces, let vᵢ∈{0,1}ⁿ and the vector

$$v = {\sum }_{i = 0}^{⌈ log q ⌉ - 1} {2}^{i} {v}_{i} ,$$

the BD(v) function takes a vector v as input and outputs a higher-dimensional vector \tilde{v}=(v₀; . . . ; v_{┌log q┐-1})∈{0,1}^{┌log q┐}.

Similarly, P2(x) function takes a vector

$$x ∈ {ℤ}_{q}^{n}$$

as input and outputs a higher-dimensional vector x̅=(x; 2x; . . . ;

$${2}^{⌈ log q ⌉ - 1} x ) ∈ {ℤ}_{q}^{n ⌈ log q ⌉} ;$$

the relationship between BD(v) and P2(x) satisfies BD(v)^{T}·P2(x)=v^{T}x=\tilde{v}^{T}x̅.
S56. Obtaining the re-encryption key rk_{α,f→β} associated with the control strategy f:

$${rk}_{α , f \to β} = \{ {g}^{T} , Q \} .$$

S6. The cloud server executes a ReEncrypt algorithm to re-encrypt the ciphertext based on the re-encryption key, and sends the re-encrypted ciphertext to the delegatee computing device, the step S6 may specifically include the following steps:
S61. Outputting the terminator ⊥ when the control strategy f≠0 or cc_{α,x}=Ø; otherwise,

$${ct}_{α , x} = ( {c}_{in} , {c}_{out} ) , {cc}_{α , x} = ( {\{ {c}_{i} \}}_{i ∈ [ l ]} ) ∈ {ℤ}_{q}^{lm} ;$$

S62. Randomly choosing a small integer a∈χ, and calculating c_{f} and

$${ct}_{β}^{T} ;$$

i.e.:

$$\begin{matrix}{c}_{f} ← {Eval}_{ct} ( f , {\{ ( {x}_{i} , {B}_{i} , {c}_{i} ) \}}_{i ∈ [ l ]} ) \\ {ct}_{β}^{T} = {ag}^{T} + ( BD ( {{c}^{′}}_{f}^{T} ) \vert {c}_{out}^{T} ) \cdot Q\end{matrix}$$

where c_{f} is the result obtained by running the Eval_{ct} algorithm; ct_{β}^{T} denotes the transpose of the first part ct_{β} of the re-encrypted ciphertext c_{β}; f is the strategy function; xᵢ denotes the component of the attribute vector x; Bᵢ is the public parameter; cᵢ is the element of the second part cc_{α,x} of the ciphertext c_{α,x}; g^{T} denotes the first part of the re-encryption key rk_{α,f→β}; BD denotes one of the vector decomposition functions;

$${{c}^{′}}_{f}^{T}$$

denotes the cascade of the matrices cᵢₙ and c_{f}, i.e. [cᵢₙ|c_{f}]; and Q denotes the second part of the re-encryption key rk_{α,f→β}.
S63. Outputting re-encrypted ciphertext c_{β}:

$${c}_{β} = ( {ct}_{β} , {cc}_{β} = ∅ ) ;$$

where ct_{β}, cc_{β} respectively denote the first part and the second part of the re-encrypted ciphertext c_{β}.
S7. The delegatee computing device executes an Update−sk algorithm to obtain an updated private key based on the initial private key and the ciphertext for updating the initial private key, the step S7 may specifically include the following steps:
S71. First decrypting each element of the ciphertext up for updating the initial private key of the delegatee computing device using a parallel computing or multithreading approach;
S72. Converting a bit string obtained by decryption into the [symbol] _{q}^{n×m} distribution, and recombining to obtain matrix R_{β}′;
S73. Outputting the updated private key sk_{β}′, i.e:

$${sk}_{β}^{′} = ( {T}_{{A}_{β}} , {R}_{β}^{Update} )$$

where T_{A}_{_{β}} denotes the trapdoor of the delegatee computing device β;

$${R}_{β}^{Update} = {R}_{β} + {R}_{β}^{′}$$

denotes the second part of the updated public key of the delegatee computing device.
S8. The delegatee computing device decrypts the ciphertext or re-encrypted ciphertext by executing a Decrypt algorithm based on the public parameter, the private key of the delegator computing device, and the updated private key sk_{α}′, the step S8 may specifically include the following steps:
S81. Decrypting the ciphertext; specifically, calculating

$${μ}^{′} = [ \begin{matrix}{c}_{in}^{T} & {c}_{out}^{T}\end{matrix} ] \cdot [ \begin{matrix}{R}_{β} \\ {I}_{m \times m}\end{matrix} ]$$

according to the public parameter pp=(B₁, . . . , Bₗ, χ), an initial private key of the delegator sk_{α}=(T_{A}_{_{β}},R_{β}) and an initial ciphertext

$${ct}_{β , x} = ( {c}_{in} , {c}_{out} ) = ( {A}_{β}^{T} s + {e}_{in} , {D}_{β}^{T} s + {e}_{out} + μ ⌊ \frac{q}{2} ⌋ )$$

encrypted under the public key pk_{β} of the delegator computing device, for j∈[m], when

$${μ}_{j}^{′} - ⌊ \frac{q}{2} ⌋ < \frac{q}{4} , {μ}_{j} = 1 ;$$

otherwise, μⱼ=0; finally outputting μ∈{0,1} ^{m}.
S82. Decrypting the re-encrypted ciphertext; specifically, calculating

$${μ}^{′} = [ \begin{matrix}{c}_{in}^{T} & {c}_{out}^{T}\end{matrix} ] \cdot [ \begin{matrix}{R}_{β}^{Update} \\ {I}_{m \times m}\end{matrix} ]$$

according to the public parameter pp=(B₁, . . . , Bₗ, χ), the updated private key of the delegatee computing device

$${sk}_{β}^{′} = ( {T}_{{A}_{β}} , {R}_{β}^{Update} )$$

and the re-encrypted ciphertext c_{β}=(ct_{β}, cc_{β}=Ø) encrypted under the public key

$${pk}_{β}^{′} ,$$

for j∈[m], when

$${μ}_{j}^{′} - ⌊ \frac{q}{2} ⌋ < \frac{q}{4} ,$$

μⱼ=1; otherwise, μⱼ=0; finally outputting μ∈{0,1}^{m}.

According to another aspect, the present disclosure provides a system for forward-secure and quantum-attack-resistant updatable attribute-based conditional proxy re-encryption, the system comprising one or more processors configured to execute instructions to perform operations comprising: generating and disclosing a public parameter based on a security parameter; generating public-private key pairs for both a delegator and a delegatee based on the public parameter; encrypting a plaintext based on the public parameter, a public key of the delegator, and an attribute vector to generate a ciphertext, and sending the ciphertext to a re-encryption component; generating an updated public key for the delegatee and an updated ciphertext for updating a private key of the delegatee, based on a public key of the delegatee; generating a re-encryption key associated with a control strategy based on the public parameter, the public-private key pair of the delegator, an updated public key of the delegatee, and the control strategy; re-encrypting the ciphertext using the re-encryption key by the re-encryption component to generate a re-encrypted ciphertext, and sending the re-encrypted ciphertext to the delegatee; generating an updated private key based on the private key of the delegatee and the updated ciphertext for updating the private key of the delegatee; and decrypting the ciphertext or the re-encrypted ciphertext based on the public parameter, the private key of the delegator, and the updated private key of the the delegatee.

According to yet another aspect, the present disclosure provides a non-transitory computer-readable storage medium storing instructions that, when executed by one or more processors, cause the processors to perform a method comprising: generating and disclosing a public parameter based on a security parameter; generating public-private key pairs for both a delegator and a delegatee based on the public parameter; encrypting a plaintext based on the public parameter, a public key of the delegator, and an attribute vector to generate a ciphertext, and sending the ciphertext to a re-encryption component; generating an updated public key for the delegatee and an updated ciphertext for updating a private key of the delegatee, based on a public key of the delegatee; generating a re-encryption key associated with a control strategy based on the public parameter, the public-private key pair of the delegator, an updated public key of the delegatee, and the control strategy; re-encrypting the ciphertext using the re-encryption key by the re-encryption component to generate a re-encrypted ciphertext, and sending the re-encrypted ciphertext to the delegatee; generating an updated private key based on the private key of the delegatee and the updated ciphertext for updating the private key of the delegatee; and decrypting the ciphertext or the re-encrypted ciphertext based on the public parameter, the private key of the delegator, and the updated private key of the the delegatee.

The “non-transitory computer-readable storage medium” encompasses a wide range of tangible and physical data storage devices that can retain instructions or data for access by a computer system. This explicitly excludes transient signals per se, such as propagating waves or signals. The medium includes, but is not limited to: Non-volatile memory (NVM): Flash-based storage: Flash memory cards, solid-state drives (SSDs), solid-state cards (SSCs), solid-state modules (SSMs). Magnetic storage: Hard disk drives (HDDs), magnetic tapes, floppy disks, flexible disks. Optical storage: CDs (e.g., CD-ROM, CD-R, CD-RW), DVDs, Blu-ray Discs (BD). Read-Only Memory (ROM) and variants: ROM, Programmable ROM (PROM), Erasable Programmable ROM (EPROM), Electrically Erasable Programmable ROM (EEPROM). Emerging and other non-volatile memories: Conductive-Bridging RAM (CBRAM), Phase-Change RAM (PRAM), Ferroelectric RAM (FeRAM), Magnetoresistive RAM (MRAM), Resistive RAM (RRAM), Silicon-Oxide-Nitride-Oxide-Silicon memory (SONOS), and more. Volatile memory (when configured as a physical storage device, excluding mere signals): Random Access Memory (RAM) and its various forms: RAM, Dynamic RAM (DRAM), Static RAM (SRAM), Synchronous DRAM (SDRAM), Double Data Rate SDRAM (DDR SDRAM), Rambus DRAM (RDRAM), among others. Memory modules: Dual in-line memory modules (DIMMs), single in-line memory modules (SIMMs), Rambus in-line memory modules (RIMMs). Networked and distributed storage: Network-attached storage (NAS) or any other storage medium that can be distributed over a network-coupled computer system, enabling stored instructions to be executed in a distributed fashion.

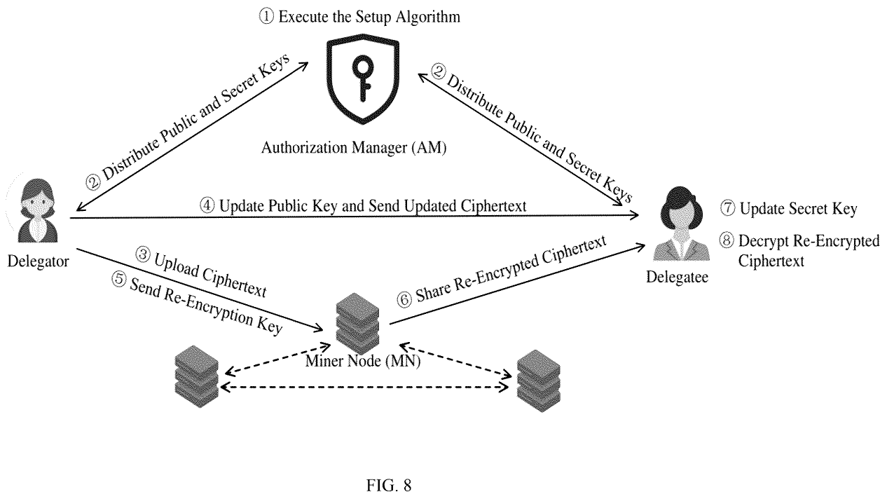

According to another embodiment of the present disclosure, as shown in FIG. 8, the re-encryption component, as defined herein, is instantiated as a miner node (also referred to as a mining node or validator node) within a blockchain network or a distributed ledger technology (DLT) framework. In this embodiment, all functional steps of the method, including Setup (S1), KeyGen (S2), Encrypt (S3), Update-pk (S4), ReKeyGen (S5), ReEncrypt (S6), Update−sk (S7), and Decrypt (S8), remain consistent with the previously described embodiment. The cryptographic algorithms, mathematical operations, and data flows are identical. The sole distinction lies in the nature and operational context of the entity performing the ReEncrypt algorithm in step S6. Specifically, the miner node, constituting the re-encryption component, is configured to: receive the re-encryption key rk_{α,f→β} and the ciphertext c_{α,x}, potentially via a blockchain transaction or a smart contract function call. Execute the ReEncrypt algorithm as detailed in steps S61-S63, performing the requisite lattice-based computations to transform c_{α,x} into the re-encrypted ciphertext c_{β}. Subsequently, the miner node disseminates the resulting c_{β} to the delegatee computing device. This dissemination may occur by broadcasting a new transaction containing c_{β} on the blockchain network, ensuring its delivery to the delegatee. The re-encryption logic, inherently defined by the ReEncrypt algorithm, may be deployed onto the blockchain network as a smart contract or a predefined, verifiable function. The miner node executes this function as part of its core duties in processing transactions and maintaining the state of the distributed ledger, seamlessly integrating the proxy re-encryption functionality into the blockchain's consensus and state transition mechanism.

It is to be explicitly understood that the specific re-encryption computations and mathematical transformations performed by the miner node are identical to those executed by a cloud server in the first embodiment. The embodiment solely exemplifies a different architectural deployment for the re-encryption component. Furthermore, in accordance with the definition provided for the “re-encryption component”, it is reiterated that this entity is not limited to the cloud server or the blockchain miner node exemplified in these embodiments. The re-encryption function may be performed by any other suitable computing entity, including but not limited to an edge computing device, a dedicated proxy server, or a peer in a peer-to-peer (P2P) network, as previously defined. Detailed descriptions of these additional embodiments are omitted herein for brevity.

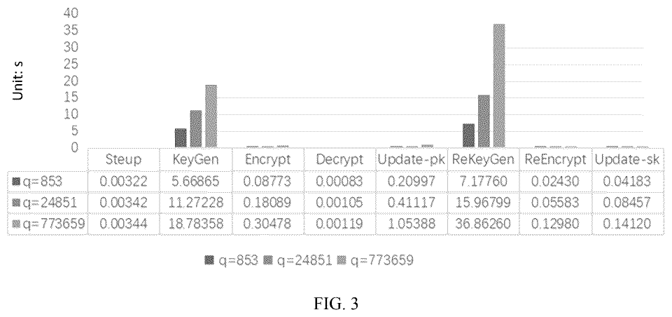

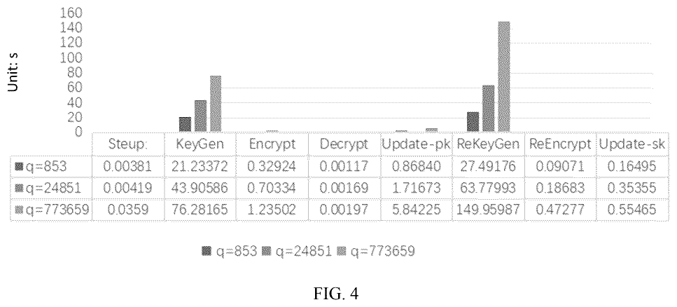

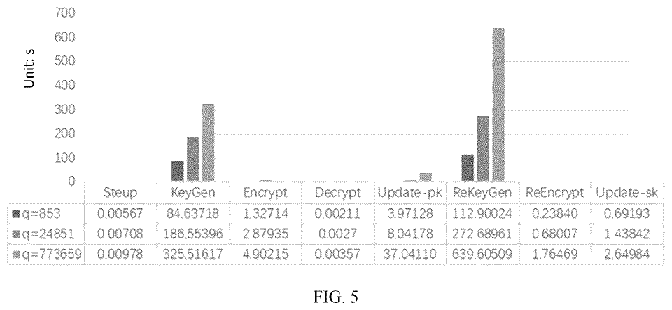

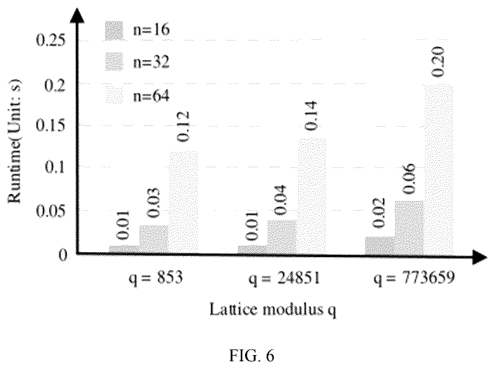

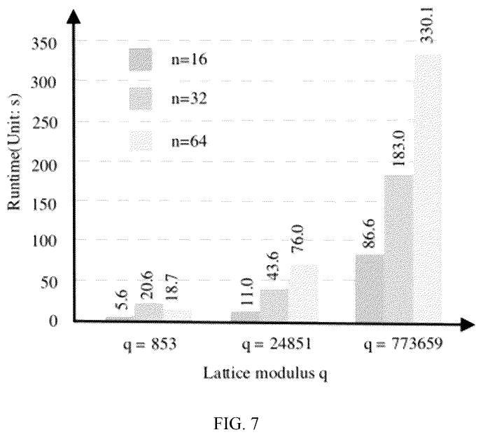

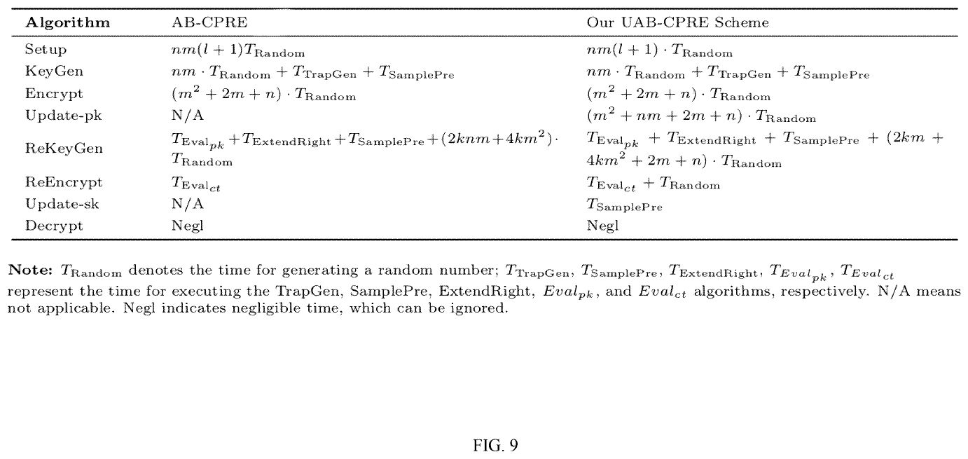

A theoretical analysis of the above embodiments demonstrates that the UAB-CPRE scheme introduces only minimal overhead compared to the existing lattice-based AB-CPRE scheme, while significantly enhancing security. Specifically, as indicated in FIG. 9, the computational complexity of the Setup, KeyGen, Encrypt, and Decrypt algorithms remains nearly identical between UAB-CPRE and AB-CPRE. The additional algorithms introduced in UAB-CPRE-Update-pk and Update-sk-require negligible computational time. Although the ReKeyGen and ReEncrypt algorithms involve extra random sampling operations, the impact on overall efficiency is marginal. These minor additions enable the UAB-CPRE scheme to achieve IND-sHRA security and forward security for the delegatee's key, substantially improving security and flexibility in practical applications. To validate the theoretical findings, the UAB-CPRE scheme was implemented and tested under various parameter settings. The experiments were conducted on a hardware platform featuring an AMD Ryzen 5 3600 processor running at 3.600 GHz with 12 cores and 32 GB of memory, using the sagemath 9.5 software environment. The runtime of all eight algorithms in the UAB-CPRE scheme was measured for different values of n (16, 32, 64) and q (853, 24851, 773659), as shown in FIGS. 3-5. The results confirm that the majority of the computational time is concentrated in the KeyGen and ReKeyGen algorithms, while the newly introduced Update-pk and Update-sk algorithms contribute minimal runtime overhead. This confirms the practical feasibility of the UAB-CPRE scheme. Furthermore, the TrapGen and SamplePre algorithms, which are critical to the KeyGen and ReKeyGen operations, were separately evaluated. As shown in FIGS. 6 and 7, the runtime of these algorithms increases with larger n and q, with SamplePre being particularly time-consuming. This indicates that optimizing the SamplePre algorithm could further enhance the overall efficiency of the UAB-CPRE scheme. The scheme's design integrates seamlessly with blockchain technology, leveraging its decentralized architecture to eliminate the need for a trusted proxy, thereby reducing reliance on centralized entities and enhancing system transparency and accountability. In cloud server environments, the UAB-CPRE scheme provides fine-grained access control and secure data sharing, making it highly suitable for applications such as cloud storage and distributed file systems. The combination of lattice-based cryptography and updatable key mechanisms ensures both quantum resistance and forward security, addressing critical vulnerabilities in existing solutions. In summary, the UAB-CPRE scheme offers a balanced approach to security and efficiency, making it a promising solution for modern data-sharing applications that require high security, flexibility, and robustness against quantum attacks.

The above embodiments and the descriptions in the specification are merely illustrative of the principle and preferred embodiments of the present disclosure. Without departing from the spirit and scope of the present disclosure, there will be various changes and modifications, and all such changes and modifications shall be considered as falling within the scope of protection of the claimed invention.

What is claimed is:

1. A computer-implemented method of forward-secure and quantum-attack-resistant updatable attribute-based conditional proxy re-encryption, the method comprising:
S1. generating and disclosing a public parameter by an authorization manager comprising one or more processors;
S2. generating public-private key pairs for both a delegator computing device and a delegatee computing device based on the public parameter by the authorization manager;
S3. encrypting a plaintext by the delegator computing device based on the public parameter, a public key of the delegator computing device, and an attribute vector to generate a ciphertext, and sending the ciphertext to a re-encryption component;
S4. generating, by the delegator computing device, an updated public key for the delegatee computing device and an updated ciphertext for updating a private key of the delegatee computing device, based on a public key of the delegatee computing device;
S5. generating, by the delegator computing device, a re-encryption key associated with a control strategy based on the public parameter, the public-private key pair of the delegator computing device, an updated public key of the delegatee computing device, and the control strategy;
S6. re-encrypting the ciphertext using the re-encryption key by the re-encryption component to generate a re-encrypted ciphertext, and sending the re-encrypted ciphertext to the delegatee computing device;
S7. generating an updated private key by the delegatee computing device based on the private key of the delegatee computing device and the updated ciphertext for updating the private key of the delegatee computing device; and
S8. decrypting the ciphertext or the re-encrypted ciphertext by the delegatee computing device based on the public parameter, the private key of the delegator computing device, and the updated private key of the the delegatee computing device.

2. The computer-implemented method of forward-secure and quantum-attack-resistant updatable attribute-based conditional proxy re-encryption according to claim 1, wherein the re-encryption component is an entity selected from a group consisting of cloud server, mining node or validator node within a blockchain or distributed ledger technology network, edge computing device, dedicated proxy server or gateway appliance, decentralized peer in a peer-to-peer network.

3. The computer-implemented method of forward-secure and quantum-attack-resistant updatable attribute-based conditional proxy re-encryption according to claim 2, wherein in step S1, the authorization manager generates the public parameter pp by executing a Setup algorithm, the step S1 further comprises:
inputting a security parameter n, then randomly and uniformly choosing l matrices B₁, . . . , Bₗ from a n×kn dimensional random matrix, wherein each element constituting the matrix belongs to a group of integers of modulus
$$q - {ℤ}_{q}^{n \times kn}$$
distribution, where k=┌log q┐, an output is the public parameter pp=(B₁, . . . , Bₗ, χ), where χ is a noise-sampling Gaussian distribution of B-bounded; and q denotes a lattice modulus.

4. The computer-implemented method of forward-secure and quantum-attack-resistant updatable attribute-based conditional proxy re-encryption according to claim 3, wherein in step S2, the authorization manager generates the public-private key pairs for both the delegator computing device and the delegatee computing device by executing a KeyGen algorithm, the step S2 further comprises:
S21. executing a trapdoor generation algorithm TrapGen to obtain matrix A_{α} and trapdoor T_{A}_{_{α}} based on the public parameter pp and an identity α of the delegator computing device; i.e:
$$( {A}_{α} , {T}_{{A}_{α}} ) ← TrapGe n ( {1}^{n} , m , q ) ;$$
where 1ⁿ denotes a security parameter; m denotes a lattice dimension, and q denotes the lattice modulus;
S22. randomly and uniformly choosing one matrix D_{α} from a n×kn dimensional random matrix, wherein each element constituting the matrix belongs to a group of integers of modulus
$$q - {ℤ}_{q}^{n \times k n}$$
distribution, and executing a sampling algorithm SamplePre to generate a sampling matrix R_{α} based on the matrix A_{α}, the trapdoor T_{A}_{_{α}}, matrix-D_{α}, and a Gaussian parameter σ; then outputting the public-private key pair (pk_{α}, sk_{α}) of the delegator computing device; wherein, the public key pk_{α}=(A_{α}, D_{α}), the private key sk_{α}=(T_{A}_{_{α}}, R_{α}); and
S23. repeating step S21 and step S22 to obtain the public key of the delegatee computing device pk_{β}=(A_{β}, D_{β}) and the private key of the delegatee sk_{β}=(T_{A}_{_{β}}, R_{β}).

5. The computer-implemented method of forward-secure and quantum-attack-resistant updatable attribute-based conditional proxy re-encryption according to claim 4, wherein in step S3, the delegator computing device encrypts the plaintext by an Encrypt algorithm to obtain the ciphertext based on the public parameter, the public key and the attribute vector of the delegator computing device, the step S3 further comprises:
S31. randomly and uniformly choosing
$$s {←}^{\$} {ℤ}_{q}^{n} ,$$
eᵢₙ∈χ^{m}, eₒᵤₜ∈χ^{m};
wherein, s denotes an unknown n-dimensional secret vector randomly chosen from the [symbol] _{q}ⁿ distribution, in other words, s denotes a n-dimensional random vector, and each element constituting the vector belongs to a group of integers of modulus q; $ denotes a random uniform sampling, eᵢₙ and eₒᵤₜ respectively denotes an n-dimensional random noise vector, each element of the n-dimensional random noise vector is independently generated according to a Gaussian distribution, and χ^{m} denotes an m-dimensional vector set with each element belonging to an χ distribution;
S32. calculating elements cᵢₙ, cₒᵤₜ of a first part ct_{α,x} of the ciphertext c_{α,x}, namely,
$$c {t}_{α , x} = ( {c}_{i n} , {c}_{out} ) ;$$
$${c}_{i n} = {A}_{α}^{T} s + {e}_{i n} ;$$
$${c}_{out} = {D}_{α}^{T} s + {e}_{out} + μ ⌊ \frac{q}{2} ⌋ ;$$
wherein matrices A_{α} and D_{α} are two components of the public key pk_{α} of the delegator computing device, μ denotes a plaintext message, q denotes the lattice modulus, and T denotes a matrix transpose operation;
S33. calculating a second part cc_{α,x} of the ciphertext;
when the attribute vector x is empty, cc_{α,x}=Ø; otherwise,
$$c {c}_{a , x} = ( {\{ {c}_{i} = {( {x}_{i} G + {B}_{i} )}^{T} s + {S}_{i}^{T} {e}_{i n} \}}_{i ∈ [ l ]} ) ∈ {ℤ}_{q}^{l m} ;$$
wherein Ø denotes empty set; cc_{α,x} denotes the second part of the ciphertext c_{α,x}; cᵢ denotes a computation result of a matrix vector (xᵢG+Bᵢ)^{T}s+Sᵢ^{T}eᵢₙ; xᵢ denotes an i-th component of an l-dimensional attribute vector x; Bᵢ denotes a matrix contained in the public parameter; Sᵢ^{T} denotes an m×kn-dimensional matrix with all elements being either 1 or −1; [symbol] _{q}^{lm} denotes an lm-dimensional vector space, wherein each component of a vector belonging to the distribution is independently and uniformly sampled at random from a finite field [symbol] _{q}, and each component of the vector belongs to [symbol] _{q}; l denotes the maximum value of i; m denotes the lattice dimension; G denotes the gadget matrix; and for the integers q≥2, n≥1, k=┌log q┐, and
$${g}^{T} = ( 1 , 2 , … , {2}^{k - 1} ) ∈ {ℤ}_{q}^{k} ,$$
a gadget matrix G is constructed as follows:
$$G = {I}_{n} ⊗ {g}^{T} = [ \begin{matrix}{g}^{T} & & \\ & ⋱ & \\ & & {g}^{T}\end{matrix} ] ∈ {ℤ}_{q}^{n \times k n} ;$$
where Iₙ denotes a unit matrix of n rows; g^{T} denotes a first part of a re-encryption key; ⊗ denotes the Kronecker product of two matrices connected to it;
S34. obtaining the ciphertext c_{α,x}=(ct_{α,x}, cc_{α,x}).

6. The computer-implemented method of forward-secure and quantum-attack-resistant updatable attribute-based conditional proxy re-encryption according to claim 5, wherein in step S4, the delegator computing device executes an Update-pk algorithm and, based on the public key of the delegatee computing device, generates an updated public key for the delegatee computing device, along with a ciphertext for updating the private key of the delegatee computing device, the step S4 further comprises:
S41. randomly and uniformly selecting a matrix
$${R}_{β}^{′} ← {ℤ}_{q}^{m \times m} ;$$
S42. converting each element of the matrix
$${R}_{β}^{′}$$
into binary, then encrypting a bit of every element of the matrix by using a parallel computing or multithreading approach, and finally reassembling them into a matrix, namely,
$$Encrypt ( pp , {pk}_{β} , μ ∈ {\{ 0 , 1 \}}^{m} , {R}_{β}^{′} ) \to up ;$$
where pk_{β} is the public key of the delegatee computing device, μ denotes the plaintext message, and up denotes the ciphertext;
thereby obtaining the ciphertext up for updating the private key of the delegatee computing device; and
S43. calculating
$${D}_{β}^{U pdate} = {D}_{β} - {A}_{β} {R}_{β}^{′}$$
to obtain an updated public key
$$p {k}_{β}^{′} = ( {A}_{β} , {D}_{β}^{U pdate} )$$
for the delegatee computing device;
where, A_{β} denotes a first part of the public key and the updated public key of the delegatee computing device; D_{β} denotes a second part of the public key of the delegatee computing device;
$${D}_{β}^{U pdate}$$
denotes a second part of the updated public key of the delegatee computing device, and
$${R}_{β}^{′}$$
denotes a matrix randomly and uniformly chosen from [symbol] _{q}^{m×m} distribution.

7. The computer-implemented method of forward-secure and quantum-attack-resistant updatable attribute-based conditional proxy re-encryption according to claim 6, wherein in step S5, the delegator computing device generates the re-encryption key associated with the control strategy by executing a ReKeyGen algorithm, the step S5 further comprises:
S51. calculating B_{f} based on the control strategy f and the public parameter pp=(B₁, . . . , Bₗ, χ):
$${B}_{f} = {Eval}_{pk} ( f , {\{ {B}_{i} \}}_{i ∈ [ l ]} ) ;$$
where f is a strategy function; Bₗ is a matrix contained in the public parameter; and B_{f} is an output of the Evalₚₖ algorithm;
S52. calculating the trapdoor T_{(A}_{_{α}}_{|B}_{_{β}}₎ of matrix A_{α}|B_{f} based on the public key pk_{α}=(A_{α}, D_{α}) and private key sk_{α}=(T_{A}_{_{α}}, R_{α}) of the delegator computing device:
$${T}_{( {A}_{α} \vert {B}_{f} )} ← ExtendRight ( {A}_{α} , {T}_{{A}_{α}} , {B}_{f} )$$
where T_{(A}_{_{α}}_{|B}_{_{f}}₎ denotes the trapdoor of matrix A_{α}|B_{f}; ExtendRight denotes a rightward expansion algorithm;
S53. computing a preimage R_{α,f} of matrix (A_{α}|B_{f}) based on the trapdoor T_{(A}_{_{α}}_{|B}_{_{f}}₎ of the matrix A_{α}|B_{f}:
$${R}_{a , f} ← SamplePre ( ( {A}_{α} \vert {B}_{f} ) , {T}_{( {A}_{α} \vert {B}_{f} )} , - {D}_{α} , σ )$$
where R_{α,f} denotes the preimage of matrix (A_{α}|B_{f}), σ is the Gaussian parameter, and SamplePre is a preimage sampling algorithm;
S54. calculating a first part g^{T} of the re-encryption key based on the updated public key
$${pk}_{β}^{′} = ( {A}_{β} , {D}_{β}^{Update} )$$
of the delegatee computing device:
$${g}^{T} = {r}_{1}^{T} ( {A}_{β} \vert {D}_{β}^{Update} ) + ( {\tilde{e}}_{0}^{T} \vert {\tilde{e}}_{1}^{T} ) ∈ {ℤ}_{q}^{1 \times 2 m}$$
where g^{T} denotes a first part of the re-encryption key rk_{α,f→β};
$${r}_{1}^{T}$$
denotes the transpose of the vector r₁, where
$${r}_{1} {←}^{\$} {ℤ}_{q}^{n} ; {\tilde{e}}_{0}^{T} , {\tilde{e}}_{1}^{T}$$
denote two random m-dimensional vectors sampled from the Gaussian distribution χ respectively, i.e.,
$${\tilde{e}}_{0} {←}^{\$} {𝒳}^{m} , {\tilde{e}}_{1} {←}^{\$} {𝒳}^{m} ;$$
S55. computing a second part of the re-encryption key rk_{α,f→β}:
$$Q = ( \begin{matrix}{E}_{1} {A}_{β} + {E}_{2} & {E}_{1} {D}_{β}^{Update} + {E}_{3} + P 2 ( {R}_{α , f} ) \\ {0}_{m \times m} & {I}_{m \times m}\end{matrix} ) ∈ {ℤ}_{q}^{( 2 k + 1 ) m \times 2 m} ;$$
where Q denotes the second part of the re-encryption key rk_{α,f→β}; E₁, E₂, E₃ respectively denote matrices 2 km×n, 2 km×m, 2 km×m randomly sampled from a noise distribution, i.e.,
$${E}_{1} {←}^{\$} {𝒳}^{2 km \times n} , {E}_{2} , {E}_{3} {←}^{\$} {𝒳}^{2 km \times m} ;$$
O_{m×m} denotes a zero matrix, namely, all elements of the matrix m×m is 0; I_{m×m} denotes a unit matrix, namely, all elements of the positive diagonal of the matrix is 1; and P2 denotes the second one of the vector decomposition function; and
S56. obtaining the re-encryption key rk_{α,f→β} associated with the control strategy f:
$${rk}_{α , f \to β} = \{ {g}^{T} , Q \} .$$

8. The computer-implemented method of forward-secure and quantum-attack-resistant updatable attribute-based conditional proxy re-encryption according to claim 7, wherein in step S51,
in Full Homomorphic Encryption, given positive integers n, q, [symbol] , m=[6n log q], matrices B₁, . . . ,
$${B}_{ℓ} ∈ {ℤ}_{q}^{n \times m} ,$$
an arbitrary control strategy f, x={x₁, . . . , [symbol] }∈{0,1 [symbol] , if ∀i∈[ [symbol] ]: cᵢ=(xᵢG+Bᵢ)^{T}s+eᵢ is satisfied, where
$$s ← {ℤ}_{q}^{n} ,$$
eᵢ←χ^{m}, then there exist three deterministic algorithms, namely, Eval_{ct}, Evalₚₖ and Evalₛᵢₘ;
\textcircled{1} Evalₚₖ(f, {Bᵢ [symbol] )→B_{f}: input of the algorithm including B₁, . . . ,
$${B}_{ℓ} ∈ {ℤ}_{q}^{n \times m}$$
and a control strategy f, the output is a matrix B_{f};
\textcircled{2} Eval_{ct}(f, {xᵢ, Bᵢ, cᵢ [symbol] →c_{f}: input of the algorithm including f, B₁, . . . ,
$${B}_{ℓ} ∈ {ℤ}_{q}^{n \times m} ,$$
xᵢ∈{0, 1}, and cᵢ=(xᵢG+Bᵢ)^{T}s+eᵢ; where G is a Gadget matrix, and the output is c_{f} which satisfies c_{f}=(f(x)G+B_{f})^{T}s+e_{f}, where ∥e_{f}∥≤B\sqrt{m}(m+1)^{d};
\textcircled{3} Evalₛᵢₘ(f,{xᵢ*,Sᵢ [symbol] ,A)→S_{f}: input of the algorithm including the control strategy f,
$${x}_{i}^{*} ∈ \{ 0 , 1 \} ,$$
Sᵢ∈{−1,1}^{m×m}, and the matrix A, and the output is the matrix S_{f} which satisfies AS_{f}−f(x)G=B_{f}, where B_{f} is an output of the algorithm Evalₚₖ.

9. The computer-implemented method of forward-secure and quantum-attack-resistant updatable attribute-based conditional proxy re-encryption according to claim 8, wherein in step S6, the re-encryption component executing a ReEncrypt algorithm to re-encrypt the ciphertext based on the re-encryption key, the step S6 further comprises:
S61. outputting the terminator ⊥ when the control strategy f≠0 or cc_{α,x}=Ø; otherwise, ct_{α,x}=(cᵢₙ, cₒᵤₜ),
$${cc}_{α , x} = ( {\{ {c}_{i} \}}_{i ∈ [ l ]} ) ∈ {ℤ}_{q}^{lm} ;$$
S62. randomly choosing an integer a∈χ, and calculating c_{f} and
$$c {t}_{β}^{T} ,$$
i.e.:
$${c}_{f} ← {Eval}_{ct} ( f , {\{ ( {x}_{i} , {B}_{i} , {c}_{i} ) \}}_{i ∈ [ l ]} )$$
$${ct}_{β}^{T} = {ag}^{T} + ( BD ( {c}_{f}^{′ T} ) \vert {c}_{out}^{T} ) \cdot Q$$
where c_{f} is the result obtained by running the Eval_{ct} algorithm;
$${ct}_{β}^{T}$$
denotes the transpose of the first part ct_{β} of the re-encrypted ciphertext c_{β}; f is the strategy function; xᵢ denotes the component of the attribute vector x; Bᵢ is the public parameter; cᵢ is the element of the second part cc_{α,x} of the ciphertext c_{α,x}; g^{T} denotes the first part of the re-encryption key rk_{α,f→β}; BD denotes one of the vector decomposition functions;
$${c}_{f}^{′ T}$$
denotes the cascade of the matrices cᵢₙ and c_{f}, i.e. [cᵢₙ|c_{f}]; and Q denotes the second part of the re-encryption key rk_{α,f→β};
S63. outputting:
$${c}_{β} = ( c {t}_{β} , {cc}_{β} = ∅ ) ;$$
where ct_{β}, cc_{β} respectively denote the first part and the second part of the re-encrypted ciphertext c_{β}.

10. The computer-implemented method of forward-secure and quantum-attack-resistant updatable attribute-based conditional proxy re-encryption according to claim 9, wherein in step S7, the delegatee computing device executing an Update−sk algorithm to obtain an updated private key based on the private key and the ciphertext for updating the private key, the step S7 further comprises:
S71. first decrypting each element of the ciphertext up for updating the private key of the delegatee computing device using a parallel computing or multithreading approach;
S72. converting a bit string obtained by decryption into the [symbol] _{q}^{n×m} distribution, and recombining to obtain matrix
$${R}_{β}^{′} ;$$
S73. outputting the updated private key
$$s {k}_{β}^{′} ,$$
i.e:
$$s {k}_{β}^{′} = ( {T}_{{A}_{β}} , {R}_{β}^{Update} )$$
where T_{A}_{_{β}} denotes the trapdoor of the delegatee computing device β;
$${R}_{β}^{Update} = {R}_{β} + {R}_{β}^{′}$$
denotes the second part of the updated public key of the delegatee computing device.

11. The computer-implemented method of forward-secure and quantum-attack-resistant updatable attribute-based conditional proxy re-encryption according to claim 10, wherein in step S8, the delegatee computing device decrypts the ciphertext or re-encrypted ciphertext by executing a Decrypt algorithm based on the public parameter, the private key of the delegator computing device, and the updated private key sk_{α}′, the step S8 further comprises:
S81. decrypting the ciphertext, calculating
$${μ}^{′} = [ \begin{matrix}{c}_{i n}^{T} & {c}_{out}^{T}\end{matrix} ] \cdot [ \begin{matrix}{R}_{β} \\ {I}_{m \times m}\end{matrix} ]$$
according to the public parameter pp=(B₁, . . . , Bₗ, χ), the private key of the delegator sk_{α}=(T_{A}_{_{β}}, R_{β}) and the ciphertext
$$c {t}_{α , x} = ( {c}_{l n} , {c}_{out} ) = ( {A}_{β}^{T} s + {e}_{in} , {D}_{β}^{T} s + {e}_{out} + μ ⌊ \frac{q}{2} ⌋ )$$
encrypted under the public key pk_{β} of the delegator computing device; for j∈[m], when
$${μ}_{j}^{′} - ⌊ \frac{q}{2} ⌋ < q / 4 ,$$
μⱼ=1; otherwise, μⱼ=0; finally, outputting μ∈{0,1}^{m}; or
S82. decrypting the re-encrypted ciphertext, calculating
$${μ}^{′} = [ \begin{matrix}{c}_{i n}^{T} & {c}_{out}^{T}\end{matrix} ] \cdot [ \begin{matrix}{R}_{β}^{Update} \\ {I}_{m \times m}\end{matrix} ]$$
according to the public parameter pp=(B₁, . . . , Bₗ, χ), the updated private key of the delegatee computing device
$$s {k}_{β}^{′} = ( {T}_{{A}_{β}} , {R}_{β}^{Update} )$$
and the re-encrypted ciphertext c_{β}=(ct_{β}, cc_{β}=Ø) encrypted under the public key
$$p {k}_{β}^{′} ;$$
for j∈[m], when
$${μ}_{j}^{′} - ⌊ \frac{q}{2} ⌋ < q / 4 , {μ}_{j} = 1 ;$$
otherwise, μⱼ=0, and finally, outputting μ∈{0,1}^{m}.

12. A system for forward-secure and quantum-attack-resistant updatable attribute-based conditional proxy re-encryption, the system comprising one or more processors configured to execute instructions to perform operations comprising:
generating and disclosing a public parameter based on a security parameter;
generating public-private key pairs for both a delegator and a delegatee based on the public parameter;
encrypting a plaintext based on the public parameter, a public key of the delegator, and an attribute vector to generate a ciphertext, and sending the ciphertext to a re-encryption component;
generating an updated public key for the delegatee and an updated ciphertext for updating a private key of the delegatee, based on a public key of the delegatee;
generating a re-encryption key associated with a control strategy based on the public parameter, the public-private key pair of the delegator, an updated public key of the delegatee, and the control strategy;
re-encrypting the ciphertext using the re-encryption key by the re-encryption component to generate a re-encrypted ciphertext, and sending the re-encrypted ciphertext to the delegatee;
generating an updated private key based on the private key of the delegatee and the updated ciphertext for updating the private key of the delegatee; and
decrypting the ciphertext or the re-encrypted ciphertext based on the public parameter, the private key of the delegator, and the updated private key of the the delegatee.

13. A non-transitory computer-readable storage medium storing instructions that, when executed by one or more processors, cause the processors to perform a method comprising:
generating and disclosing a public parameter based on a security parameter;
generating public-private key pairs for both a delegator and a delegatee based on the public parameter;
encrypting a plaintext based on the public parameter, a public key of the delegator, and an attribute vector to generate a ciphertext, and sending the ciphertext to a re-encryption component;
generating an updated public key for the delegatee and an updated ciphertext for updating a private key of the delegatee, based on a public key of the delegatee;
generating a re-encryption key associated with a control strategy based on the public parameter, the public-private key pair of the delegator, an updated public key of the delegatee, and the control strategy;
re-encrypting the ciphertext using the re-encryption key by the re-encryption component to generate a re-encrypted ciphertext, and sending the re-encrypted ciphertext to the delegatee;
generating an updated private key based on the private key of the delegatee and the updated ciphertext for updating the private key of the delegatee; and
decrypting the ciphertext or the re-encrypted ciphertext based on the public parameter, the private key of the delegator, and the updated private key of the the delegatee.
